(19) United States
(12) Patent Application Publication
(10) Pub. No.: US 2010/0310211 A1
(43) Pub. Date: Dec. 9, 2010

(54) SYSTEMS AND METHODS FOR INSTALLATION OF DEVICES AROUND AN ELEMENT

(76) Inventors: Robin Mark BABIN, Bourg, LA (US); Richard Louis Labat, JR., Thibodaux, LA (US)

Correspondence Address: SHELL OIL COMPANY, P O BOX 2463, HOUSTON, TX, 772522463, US

(21) Appl. No.: 12/761,025

(22) Filed: Apr. 15, 2010

Related U.S. Application Data
(60) Provisional application No. 61/169,752, filed on Apr. 16, 2009.

(51) Int. Cl. G02B 6/36; H01R 13/46; H01R 3/00; F16L 37/08

(52) U.S. Cl. 385/53; 439/577; 439/491; 285/80

(57) ABSTRACT

A system comprising a first conduit having a first diameter; a second conduit having a second diameter; a connection between the first conduit and the second conduit, the connection having a third diameter larger than the first diameter and the second diameter; and a shell fitted about the connection.

### REFERENCE TO PRIOR APPLICATIONS

This application claims the benefit of U.S. Provisional application Ser. No. 61/169752, filed Apr. 16, 2009.

### FIELD OF THE INVENTION

In one aspect, the invention relates to systems and methods for installing devices around an element.

### DESCRIPTION OF THE RELATED ART

United States Patent Application Number 2009/0088018 discloses a plug and socket connector arrangement for electrical or fiber optic cables including a pair of tubular locking sleeves mounted for axial and rotational displacement on the plug and connector bodies, which locking sleeves have adjacent ends provided with internal and external screw threads, respectively. The adjacent sleeve ends each contain a plurality of circumferentially spaced longitudinal slits that define a plurality of resilient threaded sectors. After the plug and socket connectors are brought into connected engagement, the locking sleeves are successively displaced from retracted separated positions axially together toward an adjacent locked position, whereby the resilient inner sleeve sectors are initially radially expanded, and the resilient outer sleeve sectors are subsequently radially contracted. The inner and outer screw threads are thus brought into threaded engagement, whereupon the locking sleeves are slightly relatively rotated to lock the sleeves together. United States Patent Application Number 2009/0088018 is herein incorporated by reference in its entirety.

United States Patent Application Number 2007/197076 discloses a water-proof electric connector module comprising a cable with two ends each provided with a connector head. Each of the connector heads of the cable further includes a front flange encircling a plurality of receiving holes. The outer wall of the connector head is provided with an outer thread, which can be coupled with the inner thread of a complementary connector head at another cable; the complementary connector with an annular groove encircling a plurality of terminal pins. There is further a rotary lock shell encircling the complementary connector head, whereby a pair of connector heads will be stably connected. The connector head with an outer thread can be sealed by a guide head cap, which has a rotary lock shell and an inner thread, capable of being engaged with the outer thread, similar to the complementary connector head. United States Patent Application Number 2007/197076 is herein incorporated by reference in its entirety.

United States Patent Application Number 2007/042630 discloses a connector housing for a plug of an electric plug-in connector with at least one plug-in part capable of insertion of at least one plug-in end in a direction of insertion into a receptacle. At least one latching element is transversally adjustable to the direction of insertion between a lock-in position and a release position. Latching elements serve to lock the plug relative to the receptacle. A release sleeve surrounds a sleeve axis and extends parallel to the direction of insertion and is capable moving, especially in the opposite direction of the direction of insertion, relative to the at least one latching element. The release sleeve actuated to shift the latching element from the lock-in position to the release position. The release sleeve exhibits a gripping area preferably surrounding the sleeve axis with a shell surface radially expanding in the direction of one axial end. United States Patent Application Number 2007/042630 is herein incorporated by reference in its entirety.

There are needs in the art for apparatus and methods for installing locking devices around electrical, pipe, optical fiber, and other types of connections; and for detecting whether a connection has been tampered with, which do not suffer from the disadvantages of the prior art apparatus and methods.

These and other needs in the art will become apparent to those of skill in the art upon review of this specification, including its drawings and claims.

### SUMMARY OF THE INVENTION

One aspect of the invention provides a system comprising a first conduit having a first diameter; a second conduit having a second diameter; a connection between the first conduit and the second conduit, the connection having a third diameter larger than the first diameter and the second diameter; and a shell fitted about the connection.

These and other aspects of the invention will become apparent to those of skill in the art upon review of this specification, including its drawings and claims.

Advantages of the invention may include one or more of the following: simplified systems and methods for installing a locking device about a connector; a locking system with tamper resistant features; and/or a system adapted to be used with a electrical, pipe, or fiber optic connection.

### BRIEF DESCRIPTION OF THE DRAWINGS

FIG. 1 is an illustration of two conduits with connectors.

FIG. 2 is an illustration of two conduits connected to each other.

FIG. 3 is an illustration of two conduits connected to each other, the connectors covered by a shell.

FIG. 4a is an illustration of two halves of a shell.

FIG. 4b is an illustration of two halves of a shell connected to make a whole shell.

FIG. 5 is an illustration of how to connect two halves of a shell to each other.

FIG. 6 illustrates a shell with a groove.

FIG. 7 is an illustration of a half of a shell.

### DETAILED DESCRIPTION OF THE INVENTION

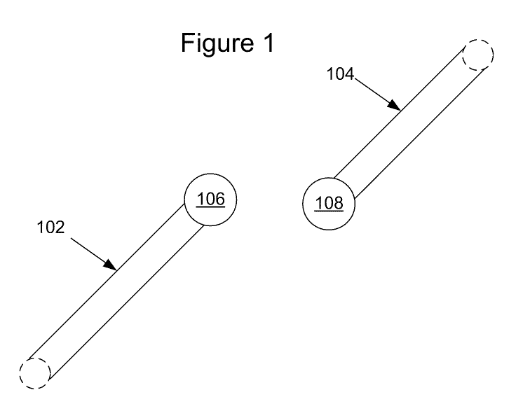

### FIG. 1:

Referring now to FIG. 1, there is illustrated conduit 102 with connector 106 and conduit 104 with connector 108. Conduit 102 has a first diameter, and connector 106 has a second diameter, where the second diameter is larger than the first diameter. Conduit 104 has a first diameter and connector 108 has a second diameter, where the second diameter is larger than the first diameter.

In one embodiment, conduits 102 and 104 are electrical cables, and connectors 106 and 108 are electrical connections. In another embodiment, conduits 102 and 104 are pipes or other tubulars, and connectors 106 and 108 are connections, such as threaded connections or welded connections. In one embodiment, conduits 102 and 104 are fiber optic cables, and connectors 106 and 108 are optical connections. Other types of conduits with a small diameter, and connectors with a larger diameter are also contemplated.

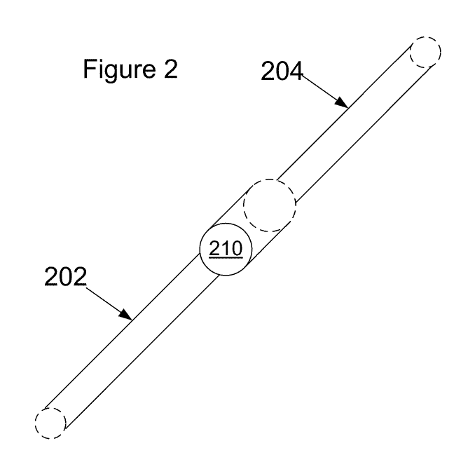

### FIG. 2:

Referring now to FIG. 2, conduit 202 is shown connected to conduit 204, by connection 210. Connection 210 could be male and female electrical connections. Connection 210 could be a threaded pin and box connector. Connection 210 could be a female connector with two ends, where conduits 202 and 204 are connected to connection 210. Connection 210 has a larger diameter than conduit 202 and 204.

In one embodiment, conduit 202 and 204 have a first diameter, for example, from about 0.5 to about 10 inches, and connection 210 has a second diameter from about 1 to about 15 inches. In some embodiments, connection 210 has a diameter from about 20% to about 60% larger than the diameter of conduits of 202 and 204.

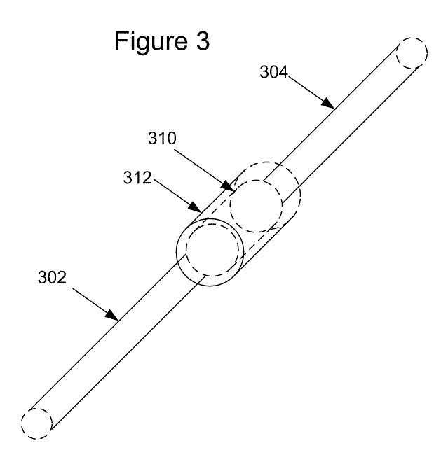

### FIG. 3:

Referring now to FIG. 3, conduit 302 is connected to conduit 304 by connector 310. Connector 310 is covered by shell 312. Shell 312 may be formed of multiple pieces, which interconnect about connector 310.

Shell 312 may be installed so that once locked in place it must be damaged or destroyed to be removed. In such a case, shell 312 provides evidence that connector 310 has been tampered with.

In one embodiment, shell 312 may also be installed about connector 310, and then fitted with one or more tapes, stickers or labels that would have to be destroyed in order to open shell 312.

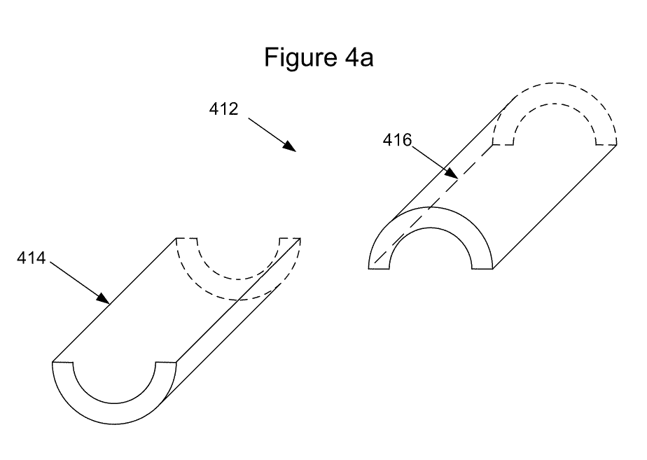

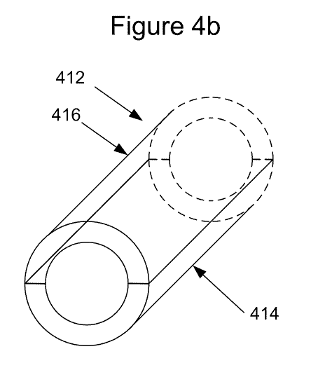

### FIGS. 4a & 4b:

Referring now to FIG. 4a, shell 412 is illustrated. Shell 412 is made up of bottom half of 414 and top half 416. Bottom half 414 has reduced diameter openings at the ends to receive the ends of a conduit, and an enlarged diameter portion in the middle of shell 412 to receive an enlarged diameter connector. Top half 416 is formed in the same way, and may be a mirror image of bottom half 414.

Referring now to FIG. 4b, top half 416 and bottom half 414 have been connected to each other to form shell 412. Shell 412 is adapted to receive a reduced diameter conduit at each end, and an enlarged diameter connector in the middle.

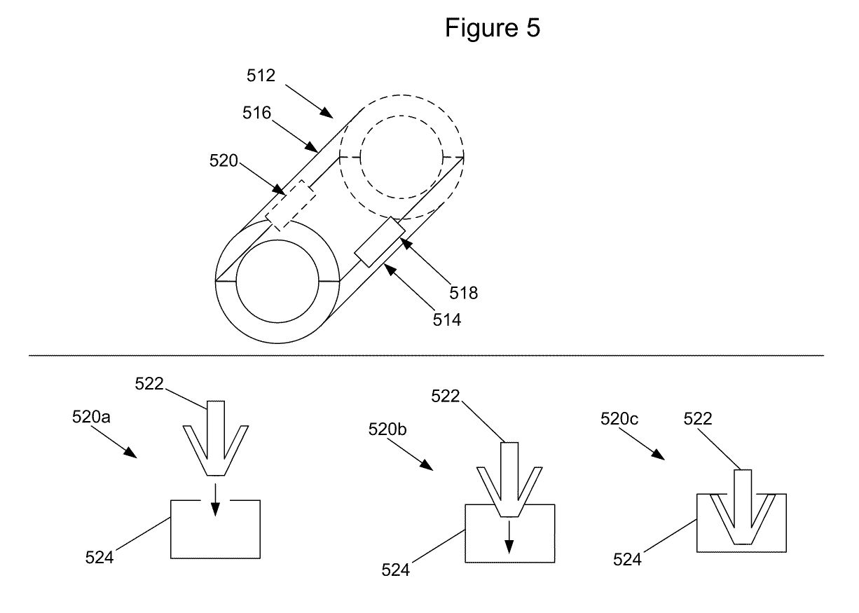

### FIG. 5:

Referring now to FIG. 5, shell 512 is illustrated with bottom half 514 connected to top half 516. Top half 516 is connected to bottom half 514 by connecting mechanisms 518 and 520.

In some embodiments, 518 and 520 may be internal to shell 512, in another embodiments one or more of 518 and 520 may be exterior to shell 512.

In one embodiment, connecting mechanism 518 or 520 may be a hinge.

In one embodiment, connecting mechanism 518 and/or 520 may be a weld.

In one embodiment, connecting mechanism 518 and/or 520 may be a male pin with a female hole.

In one embodiment, connecting mechanism 518 and/or 520 may be one or more strings, wires, straps, or other suitable closing devices such as one or more zip ties.

In one embodiment 520 is a locking hook mechanism as shown below. As shown, connector 520a includes male member 522 and female receptacle 524, where male member 522 is advanced into female receptacle 524 in the direction shown by the arrow. At 520b, male member 522 encounters the opening of female receptacle 524, so that the arms of the male member 522 are deformed inward to fit into female opening 524. At 520c, the male member 522 is fully received into the female receptacle 524 so that the arms may bias outwardly and lock male member 522 within female receptacle 524. Although the locking hook mechanism is shown with two arms, it may have other numbers of arms, for example from 1 to 6 arms, or from 2 to 4 arms.

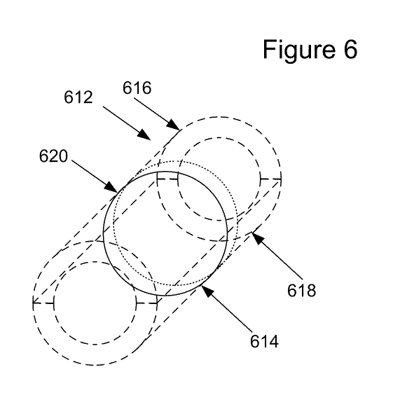

### FIG. 6:

Referring now to FIG. 6, shell 612 is shown with bottom portion 614 and top portion 616. A groove 620 has been formed in the middle of shell 612 about the circumference, which is adapted to receive a strap, wire, rope, zip tie or other such locking mechanism. Although one groove has illustrated, shell 612 maybe fitted with other numbers of grooves, for example from 2 to 5 grooves.

Shell 612 maybe also fitted with a hinge 618 to allow for a clamshell type operation where shell 612 maybe opened and fitted around a conduit and connector, enclosed with one or more zip ties or other tie mechanisms fitted into grooves 620 to lock top portion 616 relative to bottom portion 614.

Although any clamshell device is believed to be suitable for use in the invention, in some embodiments of the invention, a clamshell device is utilized that includes a locking mechanism that will allow the system to lock the clamshell device around an element upon installation. The ends of the clamshell device may be outfitted with a mating locking mechanism that locks upon contact. Some examples of such locking mechanisms include male-female connectors, rivets, screws, adhesives, welds, and/or other connectors as are known in the art.

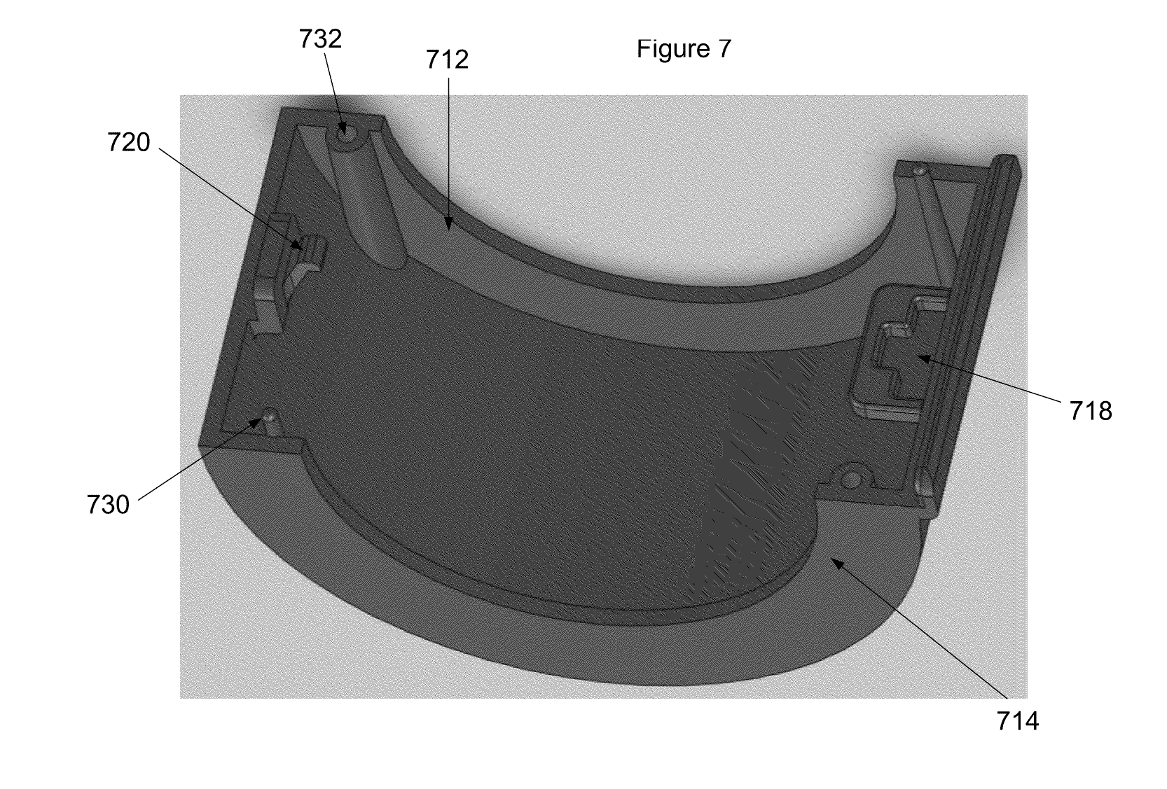

### FIG. 7:

Referring now to FIG. 7, shell 712 is shown with bottom portion 714. An identical bottom portion 714 may be used as a top portion (not shown). Bottom portion 714 includes female locking member 718 and male locking member 720. Female locking member 718 is adapted to mate with a male locking member of a top portion (not shown). Male locking member 720 is adapted to mate with a female locking member of a top portion (not shown).

Bottom portion 714 also includes male aligning pin 730 and female aligning receptacle 732. Male aligning pin 730 and female aligning receptacle 732 are adapted to mate with their counterparts of a top portion (not shown).

In practice, two identical bottom portions 714 may be fitted around a pipe, wire, or other device to be protected, and two identical bottom portions 714 may be connected to each other with the use of female locking member 718 and male locking member 720 and the aligning pins.

In some embodiments, female locking member 718 and male locking member 720 may be a single use connection mechanism, such that in order to remove shell 712 the female locking member 718 and male locking member 720 must be destroyed. The destruction of female locking member 718 and male locking member 720 would provide evidence of tampering with shell 712.

### Illustrative Embodiments:

In one embodiment, there is disclosed a system comprising a first conduit having a first diameter; a second conduit having a second diameter; a connection between the first conduit and the second conduit, the connection having a third diameter larger than the first diameter and the second diameter; and a shell fitted about the connection. In some embodiments, the conduits are selected from the group consisting of electrical, gas, liquid, and optical conduits. In some embodiments, the system also includes one or more sealing members fitted between a conduit and the shell. In some embodiments, the shell is formed of two halves. In some embodiments, the system also includes a hinge between the two halves. In some embodiments, the system also includes a locking mechanism securing the shell about the connection. In some embodiments, the locking mechanism is selected from the group consisting of straps, ties, zip ties, male pins and female holes, male hooks and female receptacles, and zip ties. In some embodiments, the locking mechanism comprises a ratchet mechanism that allows the locking mechanism to be locked but not opened. In some embodiments, the shell comprises one or more grooves adapted to receive a zip tie. In some embodiments, the shell comprises one or more of a tape, sticker, or label that indicates if the shell has been tampered with or opened.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which this invention pertains.

1. A system comprising:
a first conduit having a first diameter;
a second conduit having a second diameter;
a connection between the first conduit and the second conduit, the connection having a third diameter larger than the first diameter and the second diameter; and
a shell fitted about the connection.

2. The system of claim 1, wherein the conduits are selected from the group consisting of electrical, gas, liquid, and optical conduits.

3. The system of claim 1, further comprising one or more sealing members fitted between a conduit and the shell.

4. The system of claim 1, wherein the shell is formed of two halves.

5. The system of claim 4, further comprising a hinge between the two halves.

6. The system of claim 1, further comprising a locking mechanism securing the shell about the connection.

7. The system of claim 6, wherein the locking mechanism is selected from the group consisting of straps, ties, zip ties, male pins and female holes, male hooks and female receptacles, and zip ties.

8. The system of claim 6, wherein the locking mechanism comprises a ratchet mechanism that allows the locking mechanism to be locked but not opened.

9. The system of claim 1, wherein the shell comprises one or more grooves adapted to receive a zip tie.

10. The system of claim 1, wherein the shell comprises one or more of a tape, sticker, or label that indicates if the shell has been tampered with or opened.
